(19) United States
(12) Patent Application Publication
(10) Pub. No.: US 2012/0324732 A1
(43) Pub. Date: Dec. 27, 2012

(54) ELECTRIC SHAVER

(75) Inventors: Hiroaki Shimizu, Shiga (JP); Noboru Kobayashi, Nara (JP); Shunsuke Komori, Shiga (JP); Toshio Ikuta, Shiga (JP); Jyuzaemon Iwasaki, Shiga (JP)

(73) Assignee: PANASONIC CORPORATION, Osaka (JP)

(21) Appl. No.: 13/581,419

(22) PCT Filed: Mar. 24, 2011
(86) PCT No.: PCT/JP2011/057171

§ 371 Date: Aug. 27, 2012

(30) Foreign Application Priority Data
Mar. 26, 2010 (JP) 2010-071567

(51) Int. Cl. B26B 19/42

(52) U.S. Cl. 30/34.2

(57) ABSTRACT

Hair lifting frames are provided in a range between a top of a first outer blade located on one side in the traveling direction and a top of a second outer blade located on the other side in the traveling direction in the use of a shaver main body (an electric shaver). Accordingly, the hair lifting frames can efficiently lift body hair up, and at the same time, an influence (damage) on a skin surface can be prevented.

### TECHNICAL FIELD

The present invention relates to an electric shaver.

### BACKGROUND ART

Various types of electric shavers to shave body hair have been developed. Herein, an angle formed by the extending direction of body hair and a skin surface is called a hair rising angle. Although body hair at a large hair rising angle (for example, 45° to 60°) is easy to shave, it is difficult to shave body hair at a small hair rising angle (for example, 30° or less), that is, lying body hair. Thus, electric shavers provided with hair lifting portions in frames of outer blades having a hair lifting ability higher than conventional hair lifting portions have been developed (for example, refer to Patent Document 1).

### CITATION LIST

### Patent Literature

Patent Document 1: Japanese Patent No. 3083548

### SUMMARY OF THE INVENTION

In the conventional electric shavers, plural (three) outer blades provided with the hair lifting portions described above are provided, and generally formed into an arc-like shape projecting toward the skin surface.

Therefore, in the case of using those electric shavers, the regions having high adhesion to the skin (contact pressure) and the regions having small adhesion are both present. If hair lifting portions are provided in the regions having high adhesion, the skin surface may be damaged.

Thus, it is an object of the present invention to provide an electric shaver capable of lifting body hair efficiently by providing hair lifting frames, and capable of preventing an influence on a skin surface.

In order to solve the above-described problem, an electric shaver according to the present invention includes: a shaver main body; outer blades having blade holes defined by frames; and inner blades provided inside the outer blades to move relative to the outer blades and cut body hair inserted into the blade holes, wherein a plurality of the outer blades are formed into an arc-like shape projecting toward a skin surface and exposed on a top end surface of the shaver main body, the frames of at least one of the outer blades are provided with hair lifting frames that come into contact with the body hair to lift the body hair from the skin surface when moving on the skin surface, and the hair lifting frames are provided in a range between a top portion of a first outer blade located on one side in a traveling direction and a top portion of a second outer blade located on another side in the traveling direction when using the shaver main body.

According to the present invention, the hair lifting frames are provided in the range between the top portion of the first outer blade located on one side in the traveling direction and the top portion of the second outer blade located on the other side in the traveling direction in the use of the shaver main body. As a result, the hair lifting frames can efficiently lift the body hair up, and at the same time, an influence (damage) on the skin surface can be prevented.

### BRIEF DESCRIPTION OF THE DRAWINGS

FIG. 1 is a front view showing an electric shaver according to a first embodiment of the present invention.

FIG. 2 is a perspective view showing an inner blade of a blade unit shown in FIG. 1.

FIG. 3 is a perspective view showing a head unit of FIG. 1.

FIG. 4 is an explanatory view of an outer blade of FIG. 3.

FIG. 5 is an enlarged perspective view of a part of the outer blade of FIG. 1.

FIG. 6(a) is a cross-sectional view taken along the line A-A in FIG. 5, and FIG. 6(b) is an enlarged cross-sectional view of a short-side end portion.

FIG. 7(a) is a cross-sectional view taken along the line B-B in FIG. 5, and FIG. 7(b) is an enlarged cross-sectional view of a hair lifting portion.

FIG. 8 is an enlarged perspective view around a frame in a longitudinal direction of FIG. 7.

FIG. 9 is a cross-sectional view taken along the line C-C in FIG. 8.

FIG. 10 is a schematic view showing the outer blades (first to third net blades) of FIG. 3 viewed from a lateral side.

FIG. 11 is a schematic view showing outer blades (first and second net blades) viewed from a lateral side according to a second embodiment of the present invention.

### DESCRIPTION OF THE EMBODIMENTS

Hereinafter, embodiments according to the present invention will be described in detail below with reference to the drawings. Note that the respective embodiments described below include the identical components. Thus, those components are indicated by the common reference numerals and the overlapped explanations thereof will not be repeated.

### First Embodiment

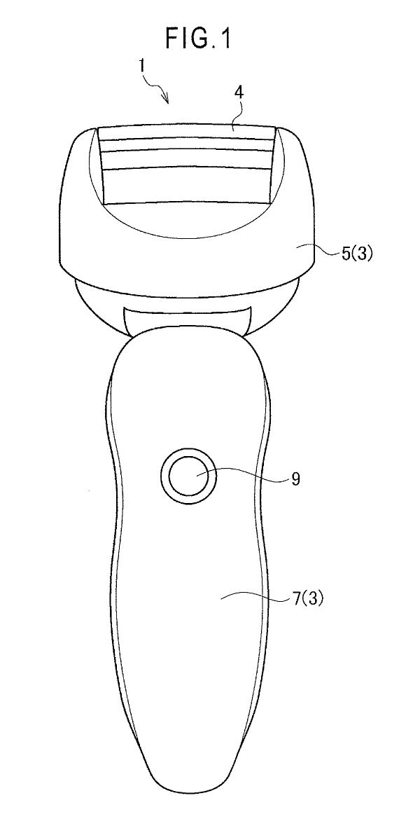

FIGS. 1 to 10 are views showing an electric shaver according to a first embodiment of the present invention.

As shown in FIG. 1, an electric shaver 1 according to the present embodiment is mainly composed of a shaver main body 3, a blade unit 4 provided on the top of the shaver main body 3, and a driving unit (not shown in the figures.) to drive the blade unit 4.

The shaver main body 3 according to the present embodiment is divided into a grip portion 7 held by a user, and a head unit 5 connected to the upper end of the grip portion 7. The head unit 5 is provided with the blade unit 4 to remove body hair, and the grip portion 7 is provided with a push-button switch 9 to control the driving unit to operate (turn on and off) the blade unit 4.

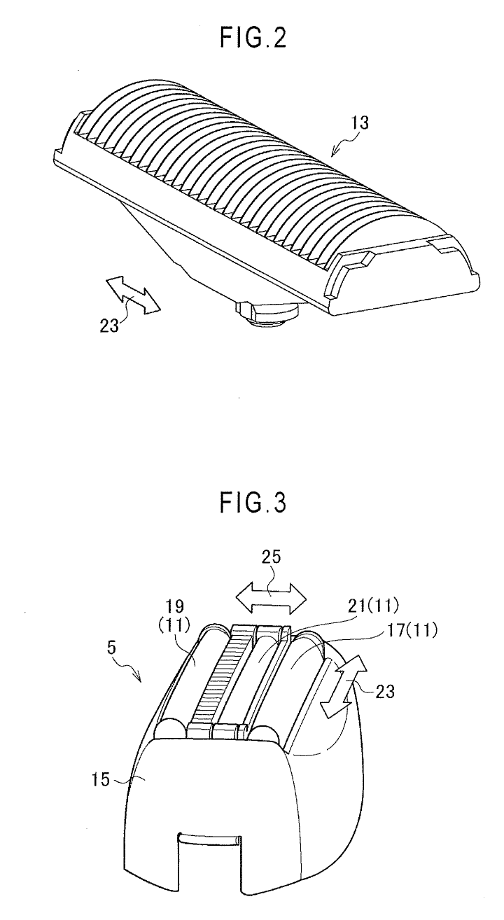

As shown in FIGS. 2 and 3, the blade unit 4 includes outer blades 11 exposed on the top end surface of the shaver main body 3, and inner blades 13 provided inside the outer blades 11 (below the outer blades 11) and configured to reciprocate in a longitudinal direction 23.

The outer blades 11 according to the present embodiment include a first net blade 17, a second net blade 19 and a third net blade 21, which are arranged parallel to each other in a short-side direction 25 that is the traveling direction (the shaving direction) of the electric shaver 1. In particular, the first to third net blades 17, 19 and 21 extend in the longitudinal direction 23 perpendicular to the short-side direction 25. The first net blade 17 and the second net blade 19 are located on both sides (on one side and the opposite side) in the short-side direction 25, and the third net blade 21 is located between the first net blade 17 and the second net blade 19.

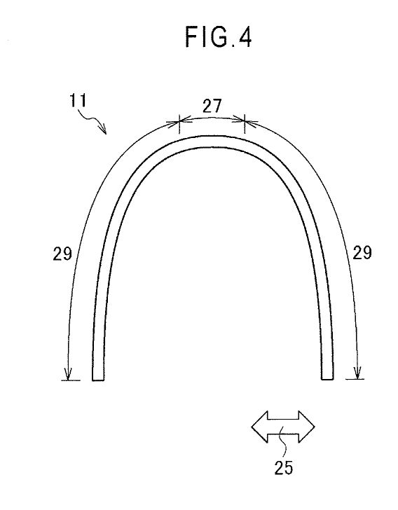

The first to third net blades 17, 19 and 21 composing the outer blades 11 are each formed into an arc-like shape projecting toward the skin of a user (toward the upper side in the present embodiment) as shown in FIG. 4. According to the present embodiment, the first to third net blades 17, 19 and 21 are formed into an inverted U-shape in cross-section in the short-side direction 25 each having a top portion 27 and both side surfaces 29 and 29. The inner blades 13 are formed to conform to the inner shapes of the respective net blades 17, 19 and 21.

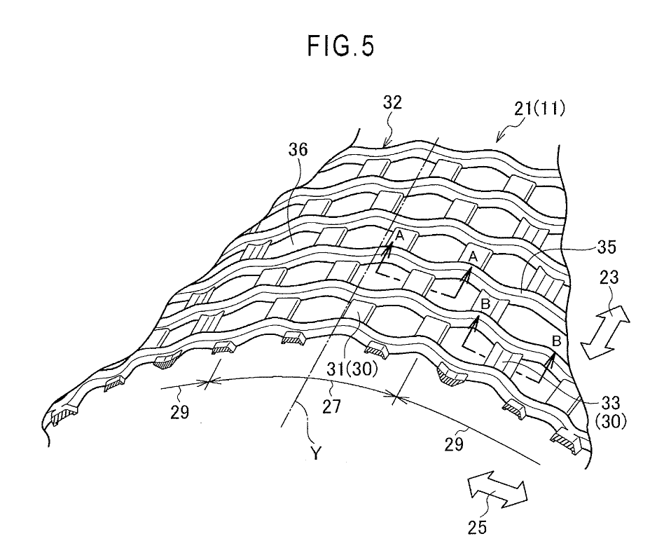

As shown in FIG. 5, the outer blades 11 are provided with a number of blade holes 36 that introduce body hair thereinto. The inner blades 13 move relative to the outer blades 11 (reciprocate in the longitudinal direction 23) so that the inner blades 13 cut the introduced body hair in cooperation with the outer blades 11.

The blade holes 36 are defined by frames 32. In other words, the frames 32 of the outer blades 11 include transverse frames 35 extending in an inverted U-shaped manner in the short-side direction 25 and vertical frames 30 extending in the longitudinal direction 23, and the blade holes 36 are defined by the transverse frames 35 and the vertical frames 30. The blade holes 36 have the dimension sufficient to introduce the body hair thereinto. Note that, in the figure, a dashed-dotted line Y is a center line (the top) passing through the middle of the top portion 27 in the short-side direction 25.

The vertical frames 30 according to the present embodiment include hair lifting frames 33 provided with hair lifting portions 45 described below, and common vertical frames 31 having a hair lifting ability lower than the hair lifting frames 33.

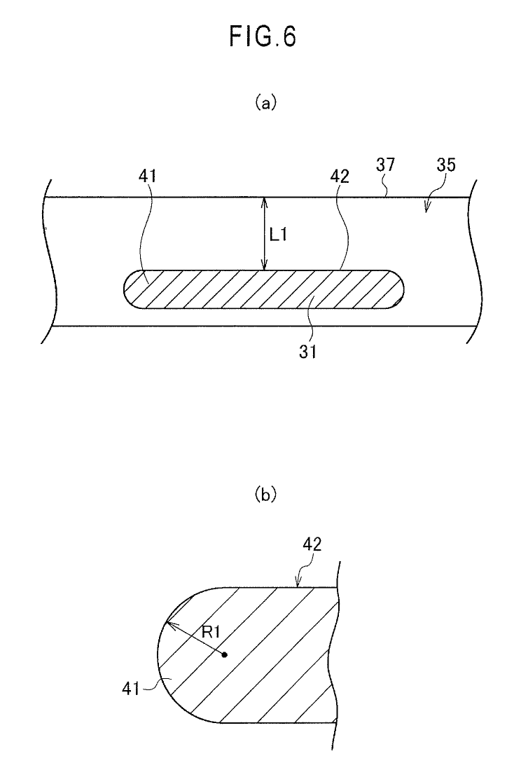

As shown in FIGS. 6(a) and 6(b), each common vertical frame 31 is formed into an approximately flat plate in cross-section. Each short-side end portion (hair lifting portion) 41 of the common vertical frame 31 is formed into a semicircular shape in cross-section having a radius of curvature of R1. The R1 is preferably 10 μm, for example. Note that a surface 37 of the transverse frame 35 is located closer to the skin than a surface 42 of the common vertical frame 31, and the vertical distance between the surface 42 of the common vertical frame 31 and the surface 37 of the transverse frame 35 is set to L1.

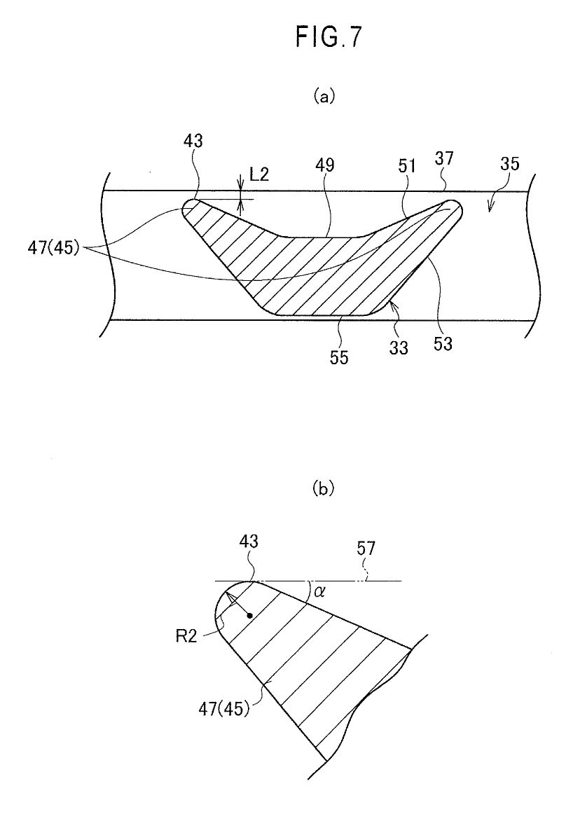

Meanwhile, as shown in FIG. 7(a), each hair lifting frame 33 is formed into a substantially symmetric U-shape in cross-section. A central outer surface 49 in the short-side direction is formed into a flat shape, and bent portions 47 are inclined upward and extend toward the outer surface of the outer blade 11 (in the upper direction in the figure) from the central outer surface 49. The front ends of the bent portions 47 serve as the hair lifting portions 45 formed into a tapered shape.

The bent portions 47 are provided with inclined upper surfaces 51 on the upper side thereof, and provided with inclined lower surfaces 53 on the lower side thereof. That is, the respective hair lifting frames 33 are composed of the central outer surface 49, the inclined upper surfaces 51, the inclined lower surfaces 53 and a bottom surface 55. The vertical distance between each short-side end portion 43 of the bent portion 47 and the surface 37 of the transverse frame 35 is set to L2. Thus, the hair lifting frames 33 are arranged in an offset manner so as to satisfy the magnitude relation of L2<L1. The difference between L1 and L2 is preferably 10 μm, for example.

As shown in FIG. 7(b), the short-side end portion 43 of the bent portion 47 is formed into a semicircular shape in cross-section having a radius of curvature of R2. The magnitude relation between R1 and R2 is set to be R2<R1. The R2 is preferably 3 μm, for example. Here, a clearance angle α formed by the inclined upper surface 51 and a reference line 57 in the short-side direction indicated by the chain double-dotted line is set larger than the clearance angle formed by the surface 41 of the common vertical frame 31 and the reference line 57 (that is 0°) as shown in FIG. 6(a).

Therefore, according to the outer blades 11 of the present embodiment, the hair lifting frames 33 can lift the lying body hair having a small angle to skin more efficiently than the common vertical frames 31. Namely, the hair lifting frames 33 have a hair lifting ability higher than the common vertical frames 31.

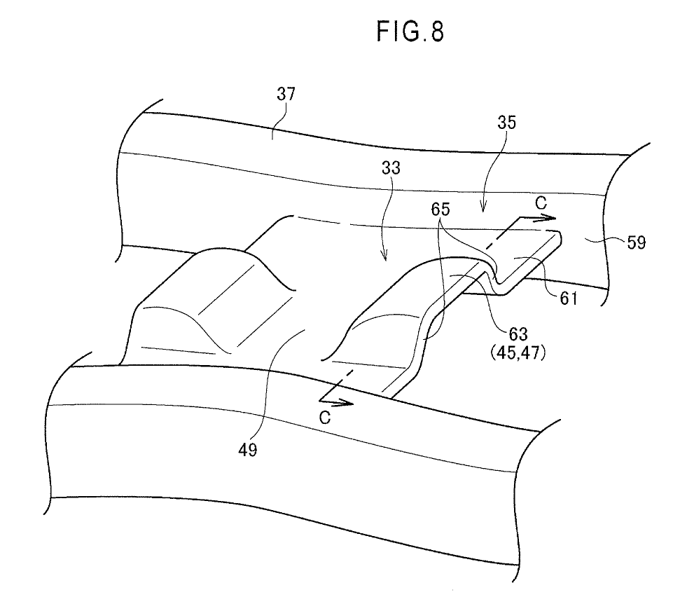

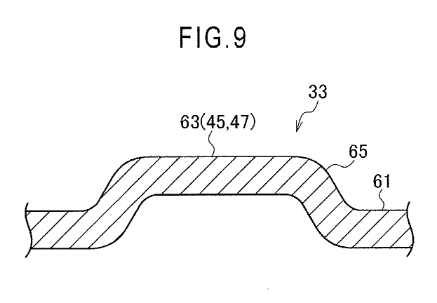

As shown in FIGS. 8 and 9, each longitudinal end portion 61 of the hair lifting frame 33 extends substantially linearly in cross-section from a side wall 59 of the transverse frame 35 in the longitudinal direction. Each longitudinal end portion 61 is connected to a longitudinal center portion 63 via a gently-curved boundary 65. A radius of curvature of the boundary 65 is preferably 10 μm, for example.

Therefore, the outer blades 11 according to the present embodiment can lift the body hair at a small hair rising angle (for example, 30° or less) efficiently due to the hair lifting frames 33 having the hair lifting ability higher than the common vertical frames 31. However, as described above, the outer blades 11 are formed into an arc-like shape projecting toward the skin surface. Thus, during the use of the electric shaver 1, the regions having high adhesion to the skin (contact pressure) and the regions having small adhesion are both present. If the hair lifting portions 33 are evenly provided in the first to third net blades 17, 19 and 21, the influence (damage) on skin is increased.

Especially, when using the electric shaver 1 including the plural outer blades (in the present embodiment, the first to third net blades 17, 19 and 21), the portion that comes first into contact with the skin (that is, the R portion of either the first net blade 17 or the second net blade 19 on the outer side in the short-side direction 25 that is the traveling direction) has higher adhesion to the skin. If the hair lifting frames 33 are provided in the regions having higher adhesion, the skin is damaged.

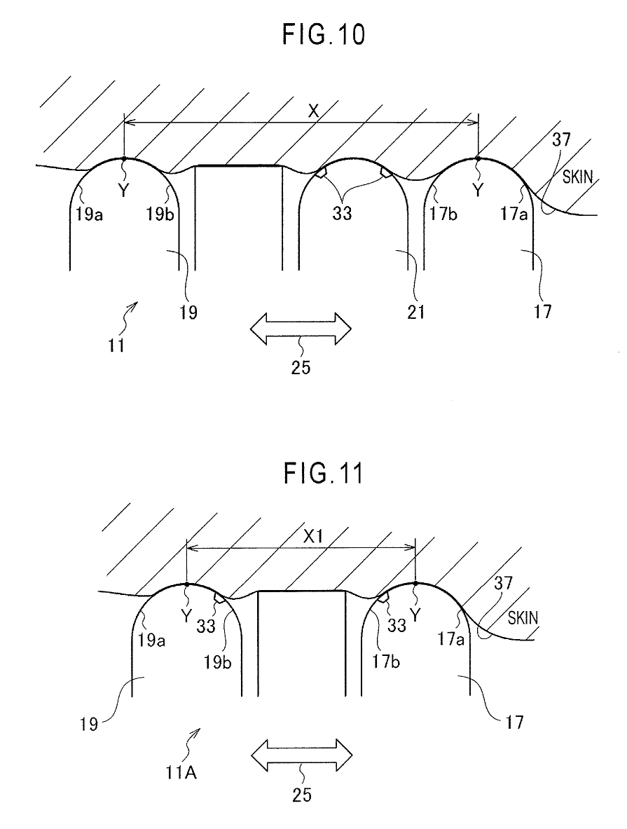

Therefore, as shown in FIG. 10, the hair lifting frames 33 according to the present embodiment are provided in a range X between a top Y of the first net blade 17 located on one side in the traveling direction and a top Y of the second net blade 19 located on the other side in the traveling direction in the use of the electric shaver 1 (the shaver main body 3).

In particular, according to the present embodiment, the vertical frames 30 of the third net blade 21 are composed of the common vertical frames 31 and the hair lifting frames 33, and the vertical frames 30 of the first net blade 17 and the second net blade 19 are respectively composed only of the common vertical frames 31.

Thus, in the electric shaver 1 according to the present embodiment, an R portion 17a of the first net blade 17 on the outer side in the short-side direction and an R portion 19a of the second net blade 19 on the outer side in the short-side direction are not provided with the hair lifting frames 33. Therefore, regardless of whether the outer blades 11 move forward or backward in the short-side direction 25 during the use of the electric shaver 1, damage to the skin surface 37 can be prevented.

In addition, the third net blade 21 provided with the hair lifting frames 33 is arranged between the first net blade 17 and the second net blade 19. Therefore, when the third net blade 21 comes into contact with the skin surface 37 in a series of operation to remove the body hair by sliding the electric shaver 1, the hair lifting frames 33 provided in the third net blade 21 can efficiently lift the lying body hair at a small angle to the skin surface 37.

As described above, in the electric shaver 1 according to the present embodiment, the hair lifting frames 33 to lift the body hair at a small hair rising angle are provided in the range X between the top Y of the first net blade 17 located on one side in the traveling direction and the top Y of the second net blade 19 located on the other side in the traveling direction in the use of the electric shaver 1 (the shaver main body 3). Accordingly, the hair lifting frames 33 can efficiently lift the body hair up and at the same time, an influence (damage) on the skin surface 37 can be prevented.

Namely, the hair lifting frames 33, which include the hair lifting portions 45 configured to have a higher hair lifting ability compared with the short-side end portion (the hair lifting portions) 41 of the common vertical frames 31, are not provided in the R portions 17a and 19a in which adhesion to the skin surface 37 is high. Thus, an influence (damage) on the skin surface 37 caused by the hair lifting frames 33 can be suppressed.

Especially, according to the present embodiment, regardless of whether the electric shaver 1 moves forward or backward in the short-side direction 25, damage to skin can be prevented while the hair lifting frames 33 can lift the body hair up efficiently. As a result, an effect of improving usability for a user can be achieved.

In addition, according to the present embodiment, the frames 32 include the vertical frames 30 extending in the longitudinal direction 23 of the outer blades 11 and the transverse frames 35 extending in the short-side direction 25, in which the hair lifting frames 33 provided with the hair lifting portions 45 are provided in the vertical frames 30. Therefore, since the body hair lifted by the hair lifting frames 33 are easily inserted in the blade holes 36, an effect of easily shaving the body hair can be achieved.

Moreover, according to the present embodiment, the hair lifting portions 45 of the hair lifting frames 33 are formed into a tapered shape inclined upward and extending toward the outer surface of the outer blade 11 (in the upper direction in the figure). Since the short-side end portions 43 of the hair lifting portions 45 are formed into a tapered shape in cross-section, the hair lifting portions 45 having a simple configuration can be provided. In addition, the tapered shape of the hair lifting portions 45 inclined upward and extending toward the outer surface of the outer blades 11 (in the upper direction in the figure) can prevent the body hair at a small hair rising angle from entering the gap between the hair lifting portions 45 and the skin, and can lift the lying body hair up more reliably.

Further, according to the present embodiment, the longitudinal end portions 61 of the hair lifting frames 33 are formed into an approximately linear shape in cross-section, the bent portions 47 are provided in the longitudinal center portions 63, and the longitudinal end portions 61 located on both sides are connected to the longitudinal center portions 63 via the gently-curved boundaries 65. Due to the gently-curved boundaries 65 connecting the longitudinal end portions 61 located on both sides and the longitudinal center portions 63 of the hair lifting frames 33, an influence (damage) on the skin surface 37 caused by the boundaries 65 can be prevented when sliding the outer blades 11 along the skin surface 37

### Second Embodiment

Next, a second embodiment of the present invention will be described with reference to the drawing. FIG. 11 is a view showing outer blades of an electric shaver according to the present embodiment.

An electric shaver 1A according to the present embodiment is mainly composed of the shaver main body 3, the blade unit 4 provided on the top of the shaver main body 3, and a driving unit (not shown in the figures) to drive the blade unit 4, as in the case of the first embodiment.

The main difference between the present embodiment and the first embodiment is that outer blades 11A of the blade unit 4 are composed of the first net blade 17 and the second net blade 19.

In particular, the first and second net blades 17 and 19 are arranged parallel to each other in the short-side direction 25 that is the traveling direction (the shaving direction) of the electric shaver 1A. The first net blade 17 is provided on one side in the short-side direction 25, and the second net blade 19 is provided on the other side.

In addition, the hair lifting frames 33 to sufficiently lift the body hair at a small hair rising angle are provided in the range X between the top Y of the first net blade 17 and the top Y of the second net blade 19.

Therefore, in the present embodiment, the hair lifting frames 33 are provided in at least one of an R portion 17b of the first net blade 17 on the inner side in the short-side direction and an R portion 19b of the second net blade 19 on the inner side in the short-side direction.

As in the case of the first embodiment, the electric shaver 1A according to the present embodiment having the above-described configuration can also achieve the effect that the hair lifting frames 33 can lift the body hair up efficiently, and at the same time, an influence (damage) on the skin surface 37 can be prevented since the hair lifting frames 33 are not provided in the R portions 17a and 19a in which adhesion to the skin surface 37 is high.

Although the preferred embodiments have been described above, the present invention is not limited to the foregoing embodiments, and various modifications can be made. For example, although the hair lifting frames 33 are provided only in the third net blade 21 in the first embodiment, the hair lifting frames 33 may be further provided in the R portion 17b of the first net blade 17 on the inner side in the short-side direction and the R portion 19b of the second net blade 19 on the inner side in the short-side direction.

Although the first to third net blades 17, 19 and 21 formed into an inverted U-shape viewed from a lateral side are arranged parallel to each other in the short-side direction 25 that is the traveling direction (the shaving direction) of the electric shaver 1 in the first embodiment, the present invention may be applied to the conventional electric shavers (such as an electric shaver in which first to third net blades are arranged in a triangle manner).

### REFERENCE SIGNS LIST

1 Electric shaver
3 Shaver main body
11 Outer blade
13 Inner blade
17 First net blade (first outer blade)
19 Second net blade (second outer blade)
21 Third net blade (third outer blade)
32 Frame
33 Hair lifting frame
36 Blade hole
37 Skin surface
X Range
Y Top

1. An electric shaver, comprising:
a shaver main body;
outer blades having blade holes defined by frames; and
inner blades provided inside the outer blades to move relative to the outer blades and cut body hair inserted into the blade holes,
wherein a plurality of the outer blades are formed into an arc-like shape projecting toward a skin surface and exposed on a top end surface of the shaver main body,
the frames of at least one of the outer blades are provided with hair lifting frames that come into contact with the body hair to lift the body hair from the skin surface when moving on the skin surface, and
the hair lifting frames are provided in a range between a top portion of a first outer blade located on one side in a traveling direction and a top portion of a second outer blade located on another side in the traveling direction when using the shaver main body.
